(19) United States
(12) Patent Application Publication
(10) Pub. No.: US 2023/0252654 A1
(43) Pub. Date: Aug. 10, 2023

(54) VIDEO ANALYSIS DEVICE, WIDE-AREA MONITORING SYSTEM, AND METHOD FOR SELECTING CAMERA

(71) Applicant: HITACHI INDUSTRY & CONTROL SOLUTIONS, LTD., Hitachi-shi, Ibaraki (JP)

(72) Inventors: Ryuji KAMIYA, Hitachi-shi, Ibaraki (JP); Hironori KOMI, Hitachi-shi, Ibaraki (JP); Hiroyuki KIKUCHI, Hitachi-shi, Ibaraki (JP); Naoto TAKI, Hitachi-shi, Ibaraki (JP); Yasuhiro MURAI, Hitachi-shi, Ibaraki (JP)

(73) Assignee: HITACHI INDUSTRY & CONTROL SOLUTIONS, LTD., Hitachi-shi, Ibaraki (JP)

(21) Appl. No.: 18/011,944

(22) PCT Filed: Jul. 8, 2021
(86) PCT No.: PCT/JP2021/025723

§ 371 Date: Dec. 21, 2022

(30) Foreign Application Priority Data
Jul. 10, 2020 (JP) 2020-118994

(51) Int. Cl. G06T 7/292; G06T 7/246; G06V 10/25; G06V 10/74; H04N 23/61

(52) U.S. Cl. CPC G06T 7/292; G06T 7/246; G06V 10/25; G06V 10/761; H04N 23/61

(57) ABSTRACT

A video analysis device includes a camera control unit, an image analysis unit, a tracking determination unit, and an analysis camera selection unit. The tracking determination unit is configured to calculate or acquire, from analyzed information, a moving speed of a tracked person to be tracked. The analysis camera selection unit is configured to set a camera search range based on the moving speed, and select a camera present in the camera search range as an analysis target camera for next video analysis. In addition, the camera control unit is configured to transmit, to the image analysis unit, a video of only the analysis target camera selected by the analysis camera selection unit.

### TECHNICAL FIELD

The present invention relates to a video analysis device, a wide-area monitoring system, and a method for selecting a camera.

### BACKGROUND ART

In related art, a technique of tracking a specific person by using a plurality of cameras has been known. In the related art, for example, a technique described in PTL 1 is an example of the above technique. PTL 1 describes a technique related to an information processing system in which a plurality of imaging devices and an analysis device are connected to track a moving object. In addition, the analysis device in PTL 1 includes a receiving unit configured to receive an image of an object detected according to attribute information from the imaging device, and an allocating unit configured to allocate the received image of the object with an image of a tracking target object held by a holding unit.

### CITATION LIST

### Patent Literature

PTL 1: JP-2015-2553A

### SUMMARY OF INVENTION

### Technical Problem

A large number of cameras are required to track a specific person. Therefore, a video analysis device for analyzing a video of a camera needs to analyze information transmitted from the large number of cameras, and a load on the video analysis device is increased. Further, in order to track a person in real time, it is necessary to introduce a plurality of video analysis devices according to the number of the cameras, and a hardware cost has increased.

In consideration of the above problems, an object of the invention is to provide a video analysis device, a wide-area monitoring system, and a method for selecting a camera, which are capable of reducing a load on video analysis.

### Solution to Problem

In order to solve the above problems and achieve the object, a video analysis device includes a camera control unit configured to control a plurality of cameras, an image analysis unit, a tracking determination unit, and an analysis camera selection unit. The image analysis unit is configured to analyze a video transmitted from the plurality of cameras via the camera control unit. The tracking determination unit is configured to calculate or acquire, from information analyzed by the image analysis unit, a moving speed of a tracked person to be tracked. The analysis camera selection unit is configured to set a camera search range based on the moving speed, and select, from the plurality of cameras, a camera present in the camera search range as an analysis target camera for next video analysis. In addition, the camera control unit is configured to transmit, to the image analysis unit, a video of only the analysis target camera selected from the plurality of cameras by the analysis camera selection unit. The analysis camera selection unit reduces the camera search range when the camera present in the camera search range exceeds a preset upper limit value.

A wide-area monitoring system includes a plurality of cameras configured to image a video, and a video analysis device configured to analyze the video output from the camera. As the video analysis device, the video analysis device described above is applied.

A method for selecting a camera is a method for selecting a camera that transmits a video to an image analysis unit that analyzes the video, and the method includes the following (1) to (3).

(1) Analyzing a video transmitted from a plurality of cameras.

(2) Calculating or acquiring, from analyzed information, a moving speed of a tracked person to be tracked.

(3) Setting a camera search range based on the moving speed, and selecting, from the plurality of cameras, a camera present in the camera search range as an analysis target camera for next video analysis.

In addition, the analysis camera selection unit reduces the camera search range when the camera present in the camera search range exceeds a preset upper limit value.

### Advantageous Effects of Invention

According to the video analysis device, the wide-area monitoring system, and the method for selecting a camera configured as described above, a load on video analysis can be reduced.

### BRIEF DESCRIPTION OF DRAWINGS

FIG. 1 is a block diagram illustrating an overall configuration of a wide-area monitoring system and a video analysis device according to an embodiment.

FIGS. 2A, 2B, and 2C illustrate examples of tables stored in camera information DB in the video analysis device according to the embodiment, in which FIG. 2A illustrates a number-of-cameras upper limit table, FIG. 2B illustrates a camera search angle table, and FIG. 2C illustrates a camera installation point table.

FIG. 3 is a flowchart illustrating a person tracking operation in the video analysis device according to the embodiment.

FIG. 4 is a flowchart illustrating first camera selection processing in the video analysis device according to the embodiment.

FIG. 5 is a schematic diagram illustrating the first camera selection processing in the video analysis device according to the embodiment.

FIG. 6 is a flowchart illustrating second camera selection processing in the video analysis device according to the embodiment.

FIG. 7 is a schematic diagram illustrating the second camera selection processing in the video analysis device according to the embodiment.

### DESCRIPTION OF EMBODIMENTS

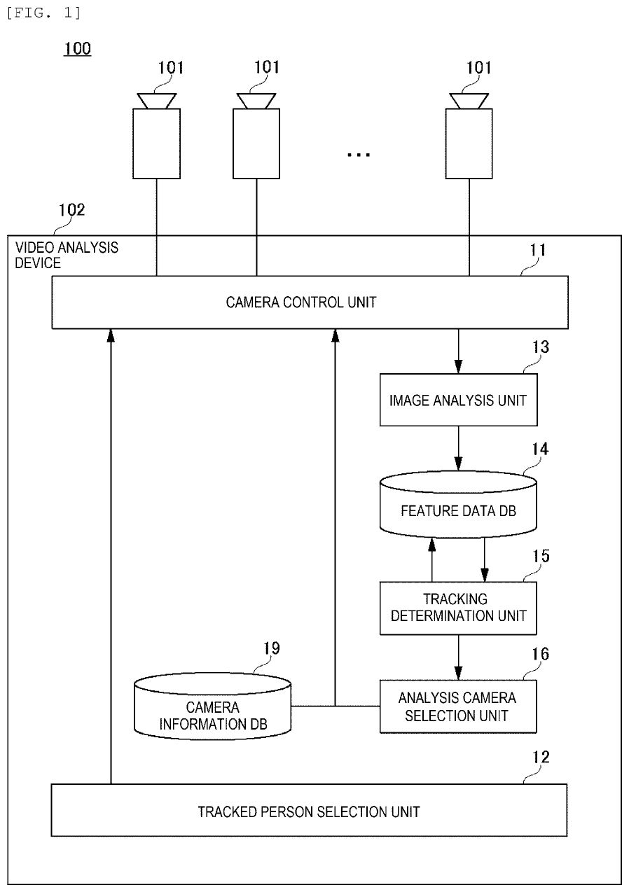

Hereinafter, an embodiment of a video analysis device, a wide-area monitoring system, and a method for selecting a camera will be described with reference to FIGS. 1 to 7. In the drawings, the same members are denoted by the same reference numerals.

### 1. Embodiment

### 1-1. Wide-Area Monitoring System and Video Analysis Device

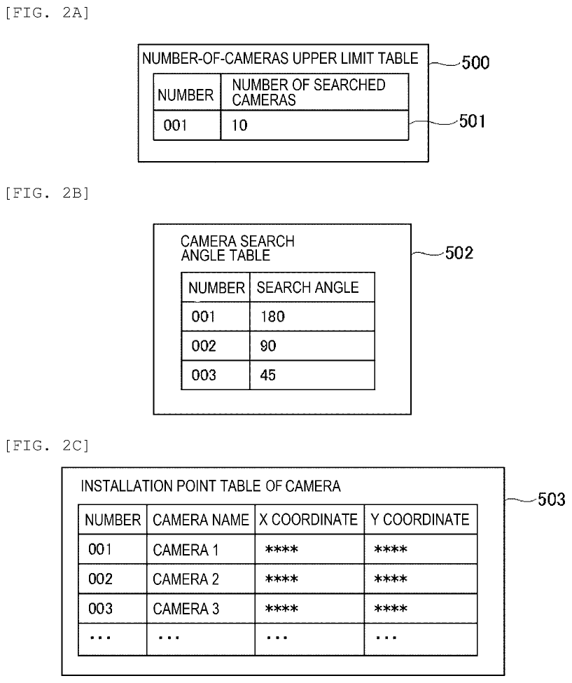

First, configurations of a wide-area monitoring system and a video analysis device according to an embodiment (hereinafter referred to as “present embodiment”) will be described with reference to FIGS. 1, 2A, 2B, and 2C.

FIG. 1 is a block diagram illustrating an overall configuration of the wide-area monitoring system and the video analysis device.

### Wide-Area Monitoring System

A wide-area monitoring system 100 illustrated in FIG. 1 is a system that is provided in a shopping center, a railway station, an airport, or the like and is used to track a specific person. The wide-area monitoring system 100 includes a plurality of cameras 101 and a video analysis device 102. The plurality of cameras 101 and the video analysis device 102 are connected via a network. A video imaged by the camera 101 is output to the video analysis device 102. Then, the video analysis device 102 analyzes the video output from the camera 101.

The wide-area monitoring system 100 may include a monitoring device that displays videos imaged by the plurality of cameras on a recording screen or a display screen.

### Video Analysis Device

Next, the video analysis device 102 will be described.

The video analysis device 102 includes a camera control unit 11, a tracked person selection unit 12, an image analysis unit 13, a feature data DB 14, a tracking determination unit 15, an analysis camera selection unit 16, and a camera information DB 19.

The camera control unit 11 is connected to the camera 101 via a network. The camera control unit 11 controls the camera 101, and switches the camera 101 that acquires a video. The camera control unit 11 acquires video information from the camera 101, and outputs the acquired video information to the image analysis unit 13. In addition, the camera control unit 11 is connected to the tracked person selection unit 12, the image analysis unit 13, and the analysis camera selection unit 16.

The tracked person selection unit 12 selects a person to be tracked (hereinafter referred to as a tracked person) from the video imaged by the camera 101. Regarding selection of the tracked person, a monitor selects the tracked person from a video displayed on a display screen of a monitoring device or the like, and outputs the selected tracked person to the tracked person selection unit 12. Information selected by the tracked person selection unit 12 is output to the camera control unit 11. Then, the camera control unit 11 controls the camera 101 that acquires the video based on the information from the tracked person selection unit 12 and the analysis camera selection unit 16 described later.

The image analysis unit 13 extracts feature data of the tracked person based on the video information output from the camera control unit 11. The image analysis unit 13 is connected to the feature data DB 14, and stores the extracted feature data of the person in the feature data DB 14. Information indicating the feature data of the person stored in the feature data DB 14 (hereinafter, feature data information) is used by the tracking determination unit 15. In addition, the image analysis unit 13 calculates a moving direction and a moving speed of the tracked person by using the feature data information, a frame rate of the camera 101, and the like, and stores the calculated moving direction and moving speed in the feature data DB 14.

The tracking determination unit 15 determines whether tracking is possible by the camera 101 that is currently tracking based on the feature data information stored in the feature data DB 14. In addition, the tracking determination unit 15 acquires the moving direction and the moving speed of the tracked person stored in the feature data DB 14, and calculates a maximum moving distance of the tracked person. The tracking determination unit 15 is connected to the analysis camera selection unit 16. Then, the tracking determination unit 15 outputs determined determination information and information regarding the moving direction and the moving speed of the tracked person to the analysis camera selection unit 16.

The camera information DB 19 is connected to the analysis camera selection unit 16. The analysis camera selection unit 16 selects the camera 101 that performs analysis based on the moving direction and the moving speed of the tracked person and camera information stored in the camera information DB 19. The analysis camera selection unit 16 outputs the selected camera information to the camera control unit 11.

FIGS. 2A to 2C are tables illustrating examples of the camera information stored in the camera information DB 19. FIG. 2A illustrates a number-of-cameras upper limit table, and FIG. 2B illustrates a camera search angle table. FIG. 2C illustrates an installation point table of the camera 101.

The tables illustrated in FIGS. 2A to 2C are used in selection processing of the camera 101 described later.

In a number-of-cameras upper limit table 500 illustrated in FIG. 2A, an upper limit 501 of the number of the cameras 101 when the camera 101 that performs analysis is selected is set. The upper limit 501 is set in advance for each video analysis device 102.

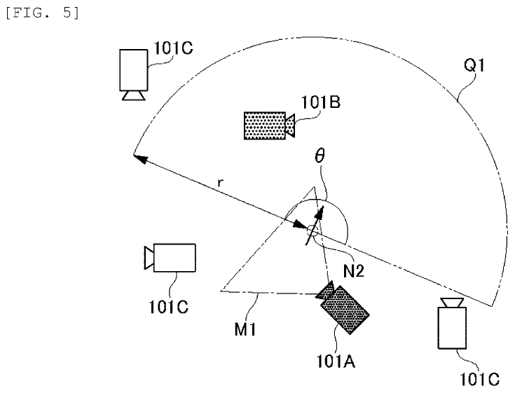

A search angle θ (see FIG. 5) used in the selection processing of the camera 101 is stored in a camera search angle table 502 illustrated in FIG. 2B. A plurality of angles are set for the search angle θ, and are sorted in descending order of their values. In an installation point table 503 of the camera 101 illustrated in FIG. 2C, information indicating installation points of the cameras 101 are stored. The information indicating the installation points is set, for example, by coordinate information including X coordinates and Y coordinates. In addition, information indicating imaging directions of the cameras 101 may be stored in the installation point table 503.

As the video analysis device 102 having the configuration described above, for example, a computer device is applied. That is, the video analysis device 102 includes a central processing unit (CPU), a read only memory (ROM), and a random access memory (RAM). Further, the video analysis device 102 includes a non-volatile storage and a network interface. The CPU, the ROM, the RAM, the non-volatile storage, and the network interface are connected to each other via a system bus.

The CPU reads out, from the ROM, a program code of software for implementing the processing units 11 to 16 provided in the video analysis device 102, and executes the program code. In addition, variables, parameters, and the like generated during calculation processing of the CPU are temporarily written in the RAM.

As the non-volatile storage, for example, a large-capacity information storage medium such as a hard disk drive (HDD) or a solid state drive (SSD) is used. In the non-volatile storage, a program for executing a processing function of the video analysis device 102 is recorded. In addition, the feature data DB 14 and the camera information DB 19 are provided in the non-volatile storage.

As the network interface, for example, a network interface card (NIC) is used. The network interface transmits and receives various kinds of information to and from the outside via a local area network (LAN) dedicated line or the like.

In the present embodiment, an example in which the computer device is applied as the video analysis device 102 has been described, but the invention is not limited thereto. A part or all of components, functions, processing units, and the like of the video analysis device 102 may be implemented by hardware by, for example, designing an integrated circuit. The above configurations, functions, or the like may also be implemented by software by means of a processor interpreting and executing a program for implementing respective functions. Information on a program, a table, and a file for implementing each function can be stored in a recording device such as a memory, a hard disk, and a solid state drive (SSD), or in a recording medium such as an IC card, an SD card, and a DVD.

### 2. Operation Example

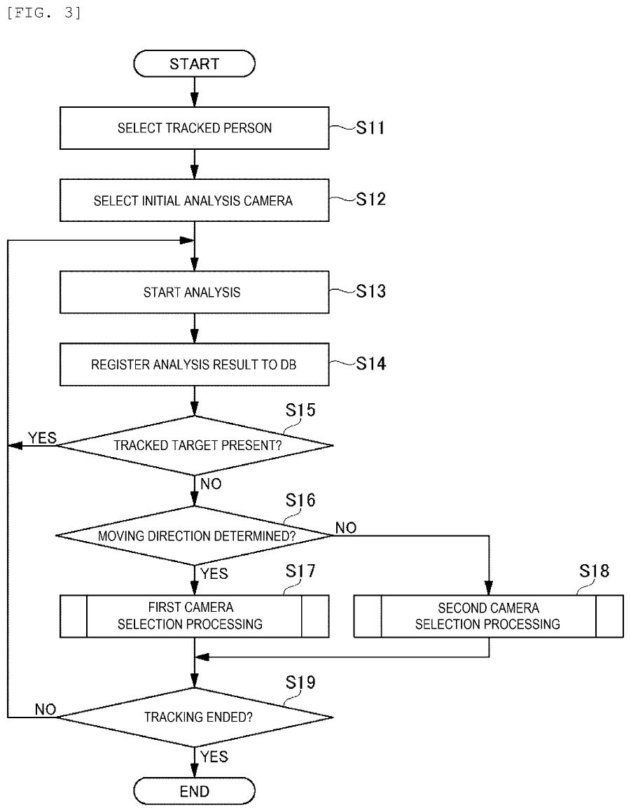

Next, an example of an operation of the video analysis device 102 having the configuration described above will be described with reference to FIGS. 3 to 7.

### 2-1. Person Tracking Operation

First, a person tracking operation will be described with reference to FIG. 3.

FIG. 3 is a flowchart illustrating the person tracking operation.

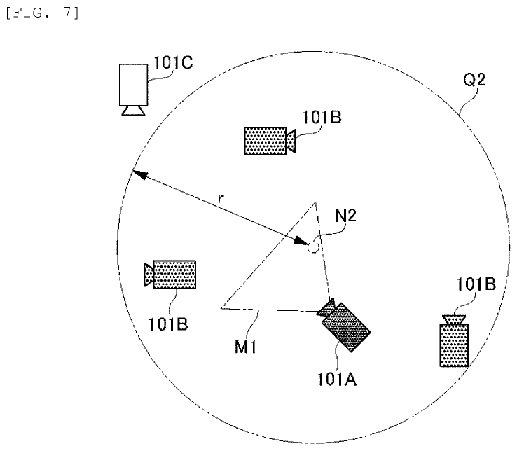

As illustrated in FIG. 3, the monitor first selects a tracked person from the video imaged by the camera 101 via the tracked person selection unit 12 (step S11). The tracked person selection unit 12 outputs information of the camera 101 in which the selected tracked person is imaged to the camera control unit 11. Then, the camera control unit 11 selects a camera 101A (see FIGS. 5 and 7) that imaged the tracked person as an initial analysis camera (step S12). Hereinafter, the camera 101A that performs analysis is referred to as an analysis target camera 101A.

When the selection processing of the initial analysis camera in the processing in step S12 is completed, the camera control unit 11 outputs video information imaged by the analysis target camera 101A to the image analysis unit 13. Then, the image analysis unit 13 starts analysis processing based on the video output from the camera control unit 11 (step S13).

The analysis processing in step S13 is performed by, for example, deep learning. The image analysis unit 13 divides and executes the processing in two stages. In the first stage, the image analysis unit 13 detects persons in a frame of the video acquired from the analysis target camera 101A, and acquires coordinate values of the persons imaged in the frame. In the second stage, the image analysis unit 13 performs extraction, attribute estimation, and the like on feature data of the persons detected in the first stage. The extraction of the feature data is used in person tracking processing between frames. In addition, the extraction processing of the feature data extracts whole body information of the persons. Further, in the attribute estimation processing, information identifying the person such as age, gender, or color of clothes of the tracked person is estimated.

Next, when the analysis by deep learning in the two stages is completed, the image analysis unit 13 registers the number of frames of the video of the analysis target camera 101A and an analysis result in the feature data DB 14 (step S14). In addition, the image analysis unit 13 calculates a moving direction and a moving speed of the tracked person based on the number of frames and feature data information, and stores the calculated moving direction and moving speed in the feature data DB 14.

When the registration processing to the feature data DB 14 in step S14 is completed, the tracking determination unit 15 determines whether the tracked person is present in the detected and analyzed persons based on the information registered in the feature data DB 14 (step S15).

In the processing in step S15, when the tracking determination unit 15 determines that the tracked person is present (YES in step S15), the process returns to step S13. That is, the video is acquired from the same analysis target camera 101A without performing the control of the camera 101 by the camera control unit 11, and the analysis processing is performed again by the image analysis unit 13.

In contrast, when the tracked person is out of an imaging range M1 of the analysis target camera 101A, in the processing in step S15, the tracking determination unit 15 determines that no tracked person is present (NO in step S15). Then, the tracking determination unit 15 determines whether the moving direction of the tracked person is determined (step S16).

In the processing in step S16, when it is determined that the moving direction of the tracked person is determined (YES in step S16), the tracking determination unit 15 performs first camera selection processing (step S17). In addition, in the processing in step S16, when it is determined that the moving direction of the tracked person is unknown (NO in step S16), the tracking determination unit 15 performs second camera selection processing (step S18). The case where the moving direction of the tracked person is unknown in the processing in step S18 is a case where the tracked person is moving at random, a case where the tracking determination unit 15 loses sight of the tracked person, or the like.

The camera control unit 11 sets the camera 101 selected in the first camera selection processing in step S17 or the second camera selection processing in step S18 as an analysis target camera 101B (see FIGS. 5 and 7). Then, video information imaged by the analysis target camera 101B is output to the image analysis unit 13. Details of the first camera selection processing and the second camera selection processing will be described later.

Next, the tracking determination unit 15 determines whether the tracking processing ended when the tracked person is out of an instruction or a monitoring range, or the like from the monitor (step S19). In the processing in step S19, when the tracking determination unit 15 determines that the tracking processing is not ended (NO in step S19), the process returns to step S13. In contrast, in the processing in step S19, when the tracking determination unit 15 determines that the tracking processing ended (YES in step S19), the person tracking operation processing is completed.

### 2-2. First Camera Selection Processing

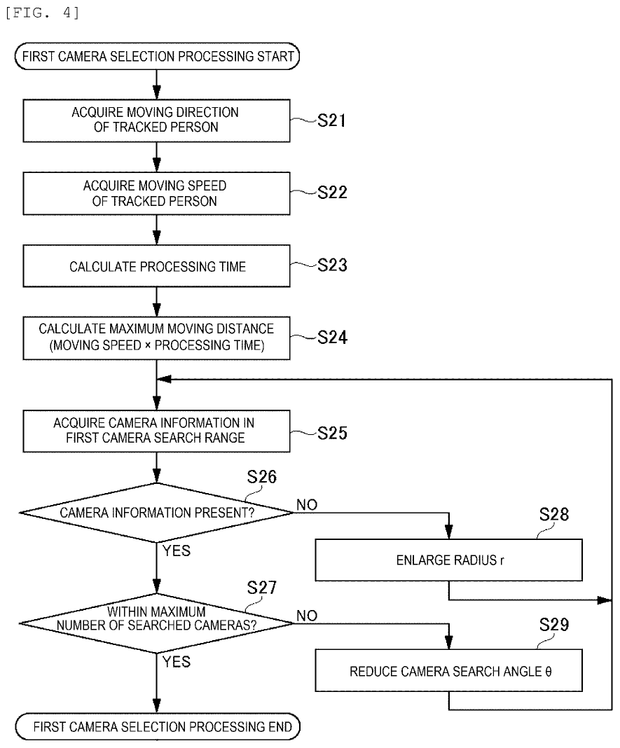

Next, the first camera selection processing will be described with reference to FIGS. 4 and 5.

FIG. 4 is a flowchart illustrating the first camera selection processing, and FIG. 5 is a schematic diagram illustrating the first camera selection processing.

As illustrated in FIG. 4, the tracking determination unit 15 acquires, from the feature data DB 14, the moving direction immediately before the tracked person is out of the imaging range M1 of the analysis target camera 101A (step S21). Here, the moving direction immediately before out of the imaging range M1 of the analysis target camera 101A is determined by a final frame in which the analysis target camera 101A imaged the tracked person. In addition, the moving direction of the tracked person in step S21 may be a direction in which the tracked person is out of an angle of view of the analysis target camera 101A. The final frame is a frame when the tracked person frames out from the imaging range M1 of the analysis target camera 101A.

Next, the tracking determination unit 15 acquires, from the feature data DB 14, the moving speed immediately before the tracked person is out of the imaging range of the analysis target camera 101A (step S22). Then, the tracking determination unit 15 calculates a processing time (step S23). Here, the processing time is a time from a time of the final frame in which the analysis target camera 101A imaged the tracked person until the tracking determination unit 15 acquires the moving speed.

The moving direction of the tracked person in step S21 and the moving speed of the tracked person in step S22 may be calculated by the tracking determination unit 15.

Next, the tracking determination unit 15 calculates a maximum moving distance of the tracked person based on the moving speed acquired in step S22 and the processing time calculated in step S23 (step S24). The maximum moving distance can be obtained by moving speed×processing time. Next, the analysis camera selection unit 16 acquires information of the camera 101 present in a first camera search range Q1 from the camera information DB 19 (step S25).

Here, a method for setting the first camera search range Q1 will be described. First, the analysis camera selection unit 16 acquires the search angle θ from the maximum moving distance calculated in step S24 and the camera search angle table 502 stored in the camera information DB 19. Then, as illustrated in FIG. 5, the analysis camera selection unit 16 sets, as the first camera search range Q1, a fan-shaped range with a point N2 immediately before the tracked person is out of the imaging range M1 as a center, with reference to the moving direction, with the maximum moving distance as a radius r, and with a preset search angle θ as a central angle.

Next, the analysis camera selection unit 16 determines whether the camera 101 is present in the first camera search range Q1, that is, whether the information of the camera 101 is present (step S26). In the processing in step S26, when it is determined that the information of the camera 101 is present (YES in step S26), the analysis camera selection unit 16 acquires the upper limit 501 from the number-of-cameras upper limit table 500 in the camera information DB 19.

Then, the analysis camera selection unit 16 determines whether the acquired number of pieces of the acquired information of the camera 101 is within the upper limit 501 of the number of cameras 101 (step S27). That is, the analysis camera selection unit 16 determines whether the number of cameras 101 present in the first camera search range Q1 is within the upper limit 501.

In addition, in the processing in step S26, when it is determined that the information of the camera 101 is not present, that is, the camera 101 is not present in the first camera search range Q1 (NO in step S26), the analysis camera selection unit 16 performs the processing in step S28. In the processing in step S28, the analysis camera selection unit 16 enlarges the radius r of the first camera search range Q1. Then, the analysis camera selection unit 16 returns to the processing in step S25, and acquires the information of the camera 101 present in the first camera search range Q1 in which the radius r is enlarged.

In the processing in step S27, when it is determined that the number of pieces of information of the camera 101 exceeds the upper limit 501 (NO in step S27), the analysis camera selection unit 16 reduces the camera search angle θ (step S29). That is, the analysis camera selection unit 16 acquires a next search angle θ from the camera search angle table 502 of the camera information DB 19. Then, the analysis camera selection unit 16 returns to the processing in step S25, and acquires the information of the camera present in the first camera search range Q1 in which the search angle θ is reduced.

In contrast, in the processing in step S27, when it is determined that the number of pieces of information of the camera 101 is within the upper limit 501 (YES in step S27), the analysis camera selection unit 16 selects the camera 101 present in the first camera search range Q1 as the analysis target camera 101B for next analysis. Accordingly, the first camera selection processing is completed. Then, the camera control unit 11 outputs the video information imaged by the analysis target camera 101B selected in the first camera selection processing to the image analysis unit 13. In addition, the camera control unit 11 does not output video information of the camera 101 that is not selected in the first camera selection processing, that is, video information of a camera 101C that is out of the first camera search range Q1, to the image analysis unit 13.

Accordingly, the number of cameras 101 that perform video analysis by the image analysis unit 13 can be reduced, and a load on the image analysis unit 13 can be reduced. As a result, the person tracking processing can be performed with a smaller number of video analysis devices 102 with respect to the number of cameras, and a hardware cost can be reduced.

### 2-3. Second Camera Selection Processing

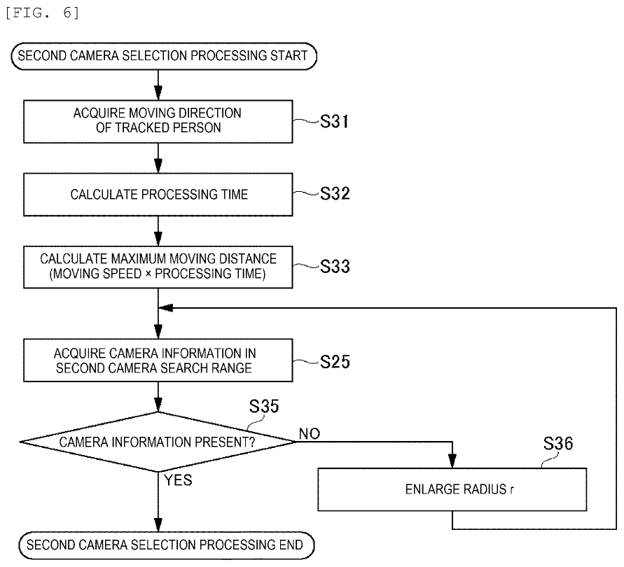

Next, the second camera selection processing will be described with reference to FIGS. 6 and 7.

FIG. 6 is a flowchart illustrating the second camera selection processing, and FIG. 7 is a schematic diagram illustrating the second camera selection processing.

As illustrated in FIG. 6, the tracking determination unit 15 acquires, from the feature data DB 14, a moving speed immediately before the tracked person is out of the imaging range Ml of the analysis target camera 101A or the tracking determination unit 15 immediately before lost the sight of the tracked person (step S31). Then, the tracking determination unit 15 calculates a processing time (step S32). Here, the processing time is a time from a time of the final frame in which the analysis target camera 101A imaged the tracked person until the tracking determination unit 15 acquires the moving speed. In the second camera selection processing, the moving speed indicated in step S31 may be calculated by the tracking determination unit 15.

Next, the tracking determination unit 15 calculates a maximum moving distance of the tracked person based on the moving speed acquired in step S22 and the processing time calculated in step S32 (step S33). Then, the analysis camera selection unit 16 acquires information of the camera 101 present in a second camera search range Q2 from the camera information DB 19 (step S34).

Here, a method for setting the second camera search range Q2 will be described. First, the analysis camera selection unit 16 acquires the maximum moving distance calculated in step S33. Then, as illustrated in FIG. 7, the analysis camera selection unit 16 sets, as the second camera search range Q2, a circular range with a point immediately before the tracked person is out of the imaging range or a point N2 in which the analysis camera selection unit 16 immediately before loses the sight of the tracked person, as a center, and with the maximum moving distance as a radius r.

Next, the analysis camera selection unit 16 determines whether the camera 101 is present in the second camera search range Q2, that is, whether the information of the camera 101 is present (step S35). In addition, in the processing in step S25, when it is determined that the information of the camera 101 is not present, that is, the camera 101 is not present in the second camera search range Q2 (NO in step S35), the analysis camera selection unit 16 performs the processing in step S36.

In the processing in step S36, the analysis camera selection unit 16 enlarges the radius r of the second camera search range Q2. Then, the analysis camera selection unit 16 returns to the processing in step S34, and acquires the information of the camera 101 present in the second camera search range Q2 in which the radius r is enlarged.

In contrast, in the processing in step S35, when it is determined that the information of the camera 101 is present (YES in step S35), the analysis camera selection unit 16 selects the camera 101 present in the second camera search range Q2 as the analysis target camera 101B for next analysis. Accordingly, the second camera selection processing is completed. Then, the camera control unit 11 outputs the video information imaged by the analysis target camera 101B selected in the second camera selection processing to the image analysis unit 13. In addition, the camera control unit 11 does not output video information of the camera 101 that is not selected in the second camera selection processing, that is, video information of the camera 101C that is out of the second camera search range Q2 to the image analysis unit 13.

Accordingly, in the second camera selection processing, similarly to the first camera selection processing, the number of cameras 101 that perform video analysis by the image analysis unit 13 can be reduced, and a load on the image analysis unit 13 can be reduced.

Also, in the second camera selection processing, similarly to the first camera selection processing, upper limit determination of the number of cameras 101 to be selected may be performed. That is, when the number of cameras 101 present in the second camera search range Q2 exceeds the upper limit 501, the analysis camera selection unit 16 reduces the radius r of the second camera search range Q2. Then, the information of the camera 101 in the second camera search range Q2 obtained by reducing the radius r is acquired, and if the information is within the upper limit 501, the camera 101 in the second camera search range Q2 is selected as the analysis target camera 101B. Accordingly, the number of cameras 101 that perform video analysis the image analysis unit 13 can be reduced.

The invention is not limited to the above embodiment illustrated in the drawings, and various modifications can be made without departing from the gist of the invention described in the claims.

### REFERENCE SIGNS LIST

11: camera control unit

12: tracked person selection unit

13: image analysis unit

14: feature data DB

15: tracking determination unit

16: analysis camera selection unit

19: camera information DB

100: wide-area monitoring system

101: camera

101A, 101B: analysis target camera

101A camera

102: video analysis device

500: number-of-cameras upper limit table

502: camera search angle table

503: installation point table

M1: imaging range

N2: point

Q1: first camera search range

Q2: second camera search range

1. A video analysis device comprising:
a camera control unit configured to control a plurality of cameras;
an image analysis unit configured to analyze a video transmitted from the plurality of cameras via the camera control unit;
a tracking determination unit configured to calculate or acquire, from information analyzed by the image analysis unit, a moving speed of a tracked person to be tracked; and
an analysis camera selection unit configured to set a camera search range based on the moving speed, and select, from the plurality of cameras, a camera present in the camera search range as an analysis target camera for next video analysis, wherein
the camera control unit is configured to transmit, to the image analysis unit, a video of only the analysis target camera selected from the plurality of cameras by the analysis camera selection unit, and
the analysis camera selection unit reduces the camera search range when the camera present in the camera search range exceeds a preset upper limit value.

2. The video analysis device according to claim 1, wherein
the tracking determination unit is configured to calculate a processing time until the moving speed is calculated or acquired, and
the analysis camera selection unit is configured to set the camera search range based on the processing time and the moving speed.

3. The video analysis device according to claim 2, wherein
the processing time is a time from a final frame, which is a frame immediately before the tracked person is out of an imaging range of the analysis target camera that is imaging the tracked person, until the tracking determination unit calculates or acquires the moving speed.

4. The video analysis device according to claim 3, wherein
the tracking determination unit is configured to calculate or acquire a moving direction of the tracked person from the information analyzed by the image analysis unit, and
the analysis camera selection unit is configured to set the camera search range based on the moving speed, the processing time, and the moving direction.

5. The video analysis device according to claim 4, wherein
the tracking determination unit is configured to determine whether the moving direction of the tracked person can be calculated or acquired from the information analyzed by the image analysis unit, and
the analysis camera selection unit
sets a first camera search range based on the moving speed, the processing time, and the moving direction when the moving direction can be calculated or acquired, and
sets a second camera search range based on the moving direction and the processing time when the moving direction cannot be calculated or acquired.

6. The video analysis device according to claim 5, wherein p1 the analysis camera selection unit is configured to calculate a maximum moving distance of the tracked person based on the processing time and the moving speed,
the first camera search range is set to a fan-shaped range with a point immediately before the tracked person is out of the imaging range of the analysis target camera as a center, with reference to the moving direction, with the maximum moving distance as a radius, and with a preset search angle as a central angle, and
the second camera search range is set to a circular range with the maximum moving distance as a radius by setting a point immediately before the tracked person is out of the imaging range of the analysis target camera or a point in which the analysis camera selection unit immediately before loses the sight of the tracked person, as a center.

7. A wide-area monitoring system comprising:
a plurality of cameras configured to image a video; and
a video analysis device configured to analyze the video output from the cameras, wherein
the video analysis device includes:
a camera control unit configured to control the plurality of cameras;
an image analysis unit configured to analyze the video transmitted from the plurality of cameras via the camera control unit;
a tracking determination unit configured to calculate or acquire, from information analyzed by the image analysis unit, a moving speed of a tracked person to be tracked; and
an analysis camera selection unit configured to set a camera search range based on the moving speed, and select, from the plurality of cameras, a camera present in the camera search range as an analysis target camera for next video analysis,
the camera control unit is configured to transmit, to the image analysis unit, a video of only the analysis target camera selected from the plurality of cameras by the analysis camera selection unit, and
the analysis camera selection unit reduces the camera search range when the camera present in the camera search range exceeds
a preset upper limit value.

8. A method for selecting a camera that transmits a video to an image analysis unit that analyzes the video, the method comprising:
analyzing a video transmitted from a plurality of cameras;
calculating or acquiring, from analyzed information, a moving speed of a tracked person to be tracked; and
setting a camera search range based on the moving speed, and selecting, from the plurality of cameras, a camera present in the camera search range as an analysis target camera for next video analysis, wherein
when the camera present in the camera search range exceeds a preset upper limit value, the camera search range is reduced.
